(19) United States
(12) Patent Application Publication
(10) Pub. No.: US 2025/0070868 A1
(43) Pub. Date: Feb. 27, 2025

(54) OPTICAL NODES, REMOTE CONTROL SYSTEMS, AND REMOTE CONTROL METHODS

(71) Applicant: NIPPON TELEGRAPH AND TELEPHONE CORPORATION, Tokyo (JP)

(72) Inventors: Tomohiro KAWANO, Musashino-shi, Tokyo (JP); Tatsuya FUJIMOTO, Musashino-shi, Tokyo (JP); Kazuhide NAKAE, Musashino-shi, Tokyo (JP); Hiroshi WATANABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/726,086

(22) PCT Filed: Jan. 14, 2022
(86) PCT No.: PCT/JP2022/001024

§ 371 Date: Jul. 1, 2024

(51) Int. Cl. H04B 10/071; H04B 10/50; H04J 14/02

(52) U.S. Cl. CPC H04B 10/071; H04B 10/503; H04J 14/02

(57) ABSTRACT

It is aimed to provide an optical node, a remote control system, and a remote control method capable of improving a communication speed of an uplink signal.

An optical node 30 according to the present invention includes a wavelength division multiplexing (WDM) coupler 33 which splits laser beams having a plurality of wavelengths supplied through the optical fiber 20 for each wavelength, the photoelectric conversion element 34 that receives and photoelectrically converts at least one of the laser beams split for each wavelength, a power storage unit 35 that stores electric power from the photoelectric conversion element 34, the reflection switches (38 to 40) that switch the other laser beams split for each wavelength between a reflection state and a non-reflection state and return the reflected laser beams to the optical fiber 20 via the WDM coupler 33, and a control unit 37 that divides information of the modules (31 and 32) into drive signals, and drives each of the reflection switches (38 to 40) by using electric power of the power storage unit 35.

### TECHNICAL FIELD

The present invention relates to a remotely controllable optical node mainly on an optical fiber network, a remote control system including the same, and a remote control method therefor.

### BACKGROUND ART

In an optical fiber network, particularly, an access network connecting a communication company and an optical terminal, optical path switching for connecting optical fiber core wires to any route or changing a route is performed at a constant frequency in order to efficiently use equipment in opening and maintenance of the optical fiber network. While such work is normally performed by going to the site to physically change the connection, a technique of performing such work remotely by using an optical switch has been proposed. For example, Non Patent Literature 1 discloses a remote control system that drives an optical switch or an optical sensor with electric power stored from optical power supply.

### CITATION LIST

### Non Patent Literature

Non Patent Literature 1: Tomohiro Kawano, Tatsuya Fujimoto, Kazuhide Nakae, Hiroshi Watanabata, Kazunori Katayama, “Enkaku mitsuji kirikae nodo no hikari kyuden seigyo ni kansuru ichi kento (in Japanese) (A Study on Optical Power Supply Control of Remote Optical Path Switching Node)”, The Institute of Electronics, Information and Communication Engineers (IEICE) Communication Society Convention, 2021, B-13-18

### SUMMARY OF INVENTION

### Technical Problem

The system disclosed in Non Patent Literature 1 includes only one reflection switch for uplink light having a switching time of several milliseconds. This system has a problem that the communication speed of an uplink signal is limited by the switching time of the reflection switch, which makes it difficult to improve the communication speed.

Therefore, in order to solve the above-described problem, the present invention aims to provide an optical node, a remote control system, and a remote control method capable of improving the communication speed of an uplink signal.

### Solution to Problem

In order to achieve the above object, the optical node according to the present invention includes a reflection switch for each of a plurality of supplied wavelengths, and divides and transmits data in parallel.

Specifically, an optical node according to the present invention includes
a wavelength division multiplexing (WDM) coupler that splits laser beams having a plurality of wavelengths supplied through an optical fiber for each wavelength,
a photoelectric conversion element that receives and photoelectrically converts at least one of the laser beams split for each wavelength,
a power storage unit that stores electric power from the photoelectric conversion element,
reflection switches that switch the other laser beams split for each wavelength between a reflection state and a non-reflection state and return the reflected laser beams to the optical fiber via the WDM coupler, and
a control unit that divides information of a module into drive signals and drives each of the reflection switches by using electric power of the power storage unit.

In addition, the present invention is a remote control method for the optical node, the remote control method including
splitting laser beams having a plurality of wavelengths supplied through an optical fiber with a wavelength division multiplexing (WDM) coupler for each wavelength,
receiving and photoelectrically converting at least one of the laser beams split for each wavelength with a photoelectric conversion element,
storing electric power from the photoelectric conversion element in a power storage unit,
dividing information of a module into drive signals and driving each of the reflection switches by using electric power of the power storage unit, and
switching by using the drive signal the reflection switches between a reflection state and a non-reflection state with respect to the other laser beams split for each wavelength and returning the reflected laser beams to the optical fiber via the WDM coupler.

Furthermore, a remote control system according to the present invention is a remote control system including
the optical node and
a monitoring control device connected to the optical node by an optical fiber,
the monitoring control device including
a plurality of lasers that supply light beams having different wavelengths from each other to the optical fiber,
a modulator that modulates the laser beam having the wavelength received by the photoelectric conversion element into the control signal,
a photodetector that receives each of the other laser beams reflected by the reflection switches, and
a management unit that combines signals from the photodetector to reproduce information of the module.

In addition, the remote control system according to the present invention has a monitoring control device connected to the optical node by the optical fiber, in which
a plurality of lasers supply laser beams having wavelengths different from each other to the optical fiber,
the laser beams having the wavelengths received by a photoelectric conversion element are modulated into a control signal,
a photodetector receives each of the other laser beams reflected by the reflection switches, and
signals from the photodetector are combined to reproduce information of the module.

Here, the control unit further drives the module using electric power of the power storage unit according to a control signal included in the laser beams received by the photoelectric conversion element. For example, the module is an optical sensor, a communication line changeover switch, or both.

According to the present invention, in a system including a monitoring control device on an optical supply side and a single or a plurality of optical nodes remotely disposed, optical power is supplied from the monitoring control device by a plurality of lasers having different wavelengths, and control of an optical switch and a module for each wavelength included in the optical nodes and uplink parallel communication at a plurality of wavelengths by the optical switch are simultaneously realized. Therefore, an uplink communication speed can be improved.

Therefore, the present invention can provide an optical node, a remote control system, and a remote control method capable of improving a communication speed of an uplink signal.

### Advantageous Effects of Invention

Therefore, the present invention can provide an optical node, a remote control system, and a remote control method capable of improving a communication speed of an uplink signal.

### BRIEF DESCRIPTION OF DRAWINGS

FIG. 1 is a diagram for describing an optical node and a remote control system thereof according to the present invention.

FIG. 2 is a diagram for describing a remote control method according to the present invention.

### DESCRIPTION OF EMBODIMENTS

Embodiments of the present invention will be described with reference to the accompanying drawings. The embodiments described below are examples of the present invention, and the present invention is not limited to the following embodiments. Note that components having the same reference signs in the present specification and the drawings denote the same components.

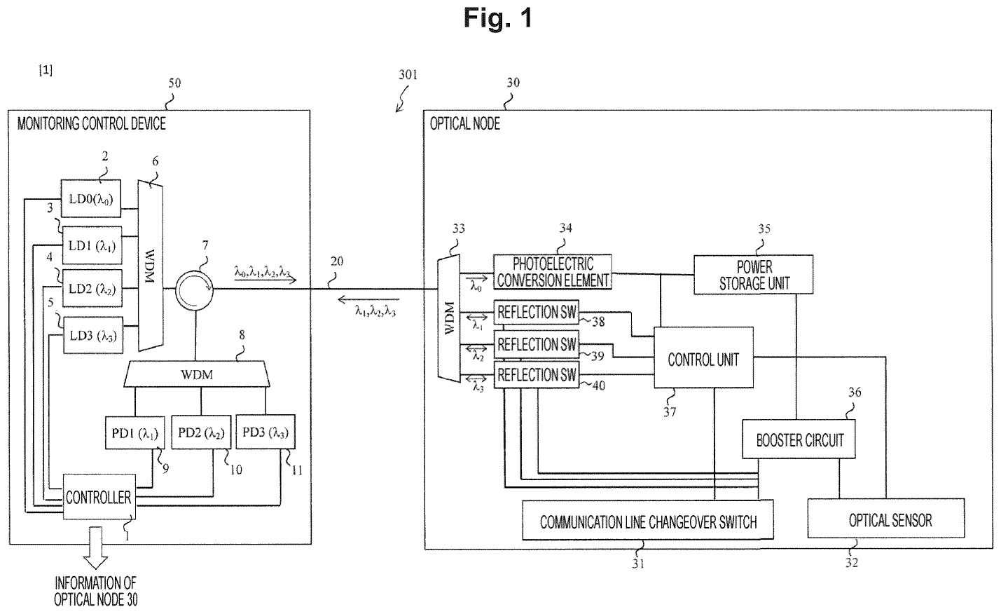

FIG. 1 is a diagram for describing a remote control system 301 of the present embodiment. The remote control system 301 includes an optical node 30 and a monitoring control device 50 connected to the optical node 30 by an optical fiber 20. The monitoring control device 50 includes
a plurality of lasers (2 to 5) that respectively supply laser beams having wavelengths different from each other to the optical fiber,
a modulator in a controller 1 that modulates a laser beam having a wavelength received by a photoelectric conversion element 34 with a control signal,
photodetectors (9 to 11) that receive each of other laser beams reflected by reflection switches (38 to 40), and
a management unit in the controller 1 that reproduces information of modules (31 and 32) by combining signals from the photodetectors (9 to 11).

The monitoring control device 50 is installed in an environment where power can be supplied. The monitoring control device 50 includes the lasers (2 to 5) that output light beams having different wavelengths, a WDM coupler 6, an optical circulator 7, a light receiving WDM coupler 8, the photodetectors (9 to 11), and the controller 1. The controller 1 includes a modulator, and instructs the laser 2 to perform modulation such that, for example, a laser beam output from the laser 2 includes information. On the other hand, the lasers 3 to 5 output unmodulated laser beams. The laser beams output from the lasers (2 to 5) are multiplexed by the WDM coupler 6 and input to a transmission line optical fiber 20 via the optical circulator 7. Note that, although the number of lasers is four (four wavelengths) in FIG. 1, the number is not limited thereto.

The optical node 30 is installed at an arbitrary place, for example, a place where there is no power supply, or the like. The optical node 30 includes
a wavelength division multiplexing (WDM) coupler 33 which splits laser beams having a plurality of wavelengths supplied through the optical fiber 20 for each wavelength,
the photoelectric conversion element 34 that receives and photoelectrically converts at least one of the laser beams split for each wavelength,
a power storage unit 35 that stores electric power from the photoelectric conversion element 34,
the reflection switches (38 to 40) that switch the other laser beams split for each wavelength between a reflection state and a non-reflection state and return the reflected laser beams to the optical fiber 20 via the WDM coupler 33, and
a control unit 37 that divides information of the modules (31 and 32) into drive signals, and drives each of the reflection switches (38 to 40) by using electric power of the power storage unit 35.

The optical node 30 is connected to the monitoring control device 50 via the transmission line optical fiber 20. As described above, the present embodiment has a configuration in which one optical node 30 is connected to the one monitoring control device 50 via the transmission line optical fiber 20.

Downlink light propagated from the monitoring control device 50 to the optical node 30 supplies drive power for modules (the communication line changeover switch 31 and the optical sensor 32) included in the optical node 30, and a control signal for switching an arbitrary port of the communication line changeover switch 31 and a control signal of the optical sensor 32 are also superimposed on the downlink light. In the present embodiment, the laser beam having a wavelength λ₀ output from the laser 2 is the drive power and the control signal. Uplink light from the optical node 30 to the monitoring control device 50 is used to communicate the state of the optical node 30 and data of the optical sensor 32 to the monitoring control device 50.

The optical node 30 causes the WDM coupler 33 to optically split downlink light from the monitoring control device 50. Out of optically split light, light having the wavelength λ₀ (light to supply drive power emitted from the laser 2) is converted into an electric signal by the photoelectric conversion element 34 and stored in the power storage unit 35. The photoelectric conversion element 34 includes an element suitable for a long wavelength of 1300 nm to 1600 nm for communication, for example, an element including indium gallium arsenide, and elements having an open voltage of 5 V or less and conversion efficiency of approximately 30 are readily available. The wavelength λ₀ is a wavelength at which the photoelectric conversion element 34 can perform efficient photoelectric conversion. The power storage unit 35 includes, for example, an electric double layer capacitor such as an EDLC.

The communication line changeover switch 31 and the optical sensor 32 operate with power obtained by boosting power stored in the power storage unit 35 to a driving voltage by a booster circuit 36. In addition, an electric signal converted by the photoelectric conversion element 34 is also input to the control unit 37, and a control signal of the communication line changeover switch 31 or the optical sensor 32 superimposed on the light having the wavelength λ₀ is extracted. The control unit 37 controls the operations of the communication line changeover switch 31 and the optical sensor 32 with the control signal.

In addition, the control unit 37 collects states of the optical node 30 and data of the optical sensor 32. When the data is to be transmitted to the monitoring control device 50, the control unit 37 divides the data into the number of reflection switches (38 to 40). Although the number of reflection switches is 3 in FIG. 1, the number is not limited thereto. The number of reflection switches is one less than the number of lasers included in the monitoring control device 50.

The control unit 37 inputs the divided pieces of data to the reflection switches (38 to 40) that reflect light (light having wavelengths λ₁ to λ₃) from the lasers 3 to 5. The reflection switches (38 to 40) perform ON/OFF operations on the divided pieces of data to modulate the intensity of the reflected light, and returns the reflected light to the monitoring control device 50. That is, the data from the optical node 30 is transmitted in parallel to the monitoring control device 50 at a plurality of wavelengths. Since the reflection switches (38 to 40) are frequently operated, the reflection switches desirably operate at a low voltage and very small power consumption of several nanowatts (nW) or less, and for example, it is preferable to use a generally available electrostatically driven MEMS optical switch requiring less drive power.

The reflected light propagating through the optical fiber 20 is input to the WDM coupler 8 via the optical circulator 7 and split for each wavelength. The reflected light having the wavelength λ₁ is received by the photodetector 9, the reflected light having the wavelength λ₂ is received by the photodetector 10, and the reflected light having the wavelength λ₃ is received by the photodetector 11. The photodetectors (9 to 11) pass information included in the received reflected light to a management unit of the controller 1. The management unit of the controller 1 reproduces the original data (that is, the data of the optical node 30) by combining the pieces of the information.

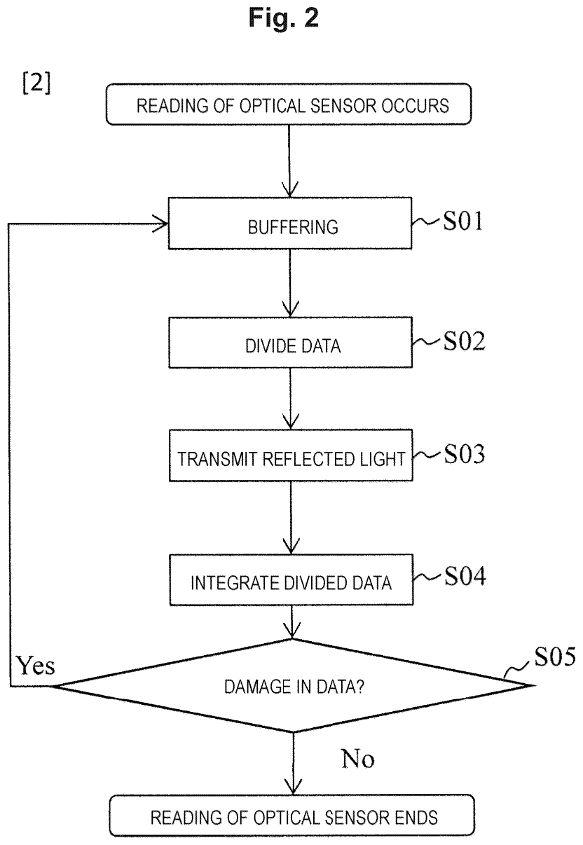

FIG. 2 is a diagram for describing a flow in which data of the optical sensor 32 is reproduced by the controller 1. First, the controller 1 instructs reading of the optical sensor 32. Specifically, the modulation unit of controller 1 modulates a laser beam from the laser 2, and outputs a signal having content instructing reading of the optical sensor 32. The control unit 37 issues a reading instruction to the optical sensor 32 by using the signal.

The read data of the optical sensor 32 is stored (buffered) in the control unit 37 (step S01). Next, the control unit 37 divides the data into a predetermined division size, and allocates an identification number (ID) to each divided piece of the data (step S02). Next, based on the divided pieces of the data, light beams (light beams having wavelengths λ₁ to λ₃) from the lasers (3 to 5) are modulated by the corresponding reflection switches (38 to 40), and an optical signal is returned to the monitoring control device 50 (step S03). Next, the monitoring control device 50 receives the received divided pieces of the data by using the photodetectors (9 to 11) corresponding to each of the wavelengths, integrates the divided pieces of the data in order of the IDs, and reproduces the read data of the optical sensor 32 (step S04). Finally, if there is no damage in the integrated data, the reading of the data by the optical sensor 32 ends (step S05).

Note that, although the example in which the three reflection switches (38 to 40) are used has been described in the present embodiment, it is needless to say that, if lasers and photodetectors having the number of wavelengths corresponding to the number of reflection switches are prepared, uplink communication with an improved communication speed can be realized by using more reflection switches.

As described in the above embodiment, according to the optical node and the system using the optical node according to the present invention, since downlink laser beam supplied from the monitoring control device to the optical node uses a plurality of wavelengths, uplink light from the optical node can be made to be multiple wavelengths, and the uplink communication speed can be improved.

In addition, it goes without saying that the remote control system includes an optical selector on the monitoring control device side to facilitate expansion such as increasing the number of optical nodes included in the system.

According to the present invention, in a system including a monitoring control device installed in a power supply environment and a single or a plurality of optical nodes remotely disposed, functions of uplink communication using optical power supply with a plurality of lasers, control of a plurality of modules included in the optical nodes, and a plurality of wavelengths can be simultaneously realized, and the communication speed can be improved.

### REFERENCE SIGNS LIST

1 Controller
2 to 5 Laser
6 WDM coupler
7 Optical circulator
8 WDM coupler
9 to 11 Photodetector
20 Optical fiber
30 Optical node
31 Communication line changeover switch
32 Optical sensor
33 WDM coupler
34 Photoelectric conversion element
35 Power storage unit
36 Booster circuit
37 Control unit
38 to 40 Reflection switch
50 Monitoring control device
301 Remote control system

1. An optical node comprising:
a wavelength division multiplexing (WDM) coupler configured to split laser beams having a plurality of wavelengths supplied through an optical fiber for each wavelength;
a photoelectric conversion element configured to receive and photoelectrically convert at least one of the laser beams split for each wavelength;
a power storage unit configured to store electric power from the photoelectric conversion element;
reflection switches configured to switch the other laser beams split for each wavelength between a reflection state and a non-reflection state and return the reflected laser beams to the optical fiber via the WDM coupler; and
a control unit configured to divide information of a module into drive signals and drive each of the reflection switches by using electric power of the power storage unit.

2. The optical node according to claim 1, wherein the control unit further drives the module using electric power of the power storage unit according to a control signal included in the laser beams received by the photoelectric conversion element.

3. The optical node according to claim 1, wherein the module is an optical sensor, a communication line changeover switch, or both.

4. A remote control system comprising:
the optical node according to claim 1; and
a monitoring control device connected to the optical node by the optical fiber, wherein
the monitoring control device includes:
a plurality of lasers configured to supply laser beams having wavelengths different from each other to the optical fiber, respectively;
a modulator configured to modulate the laser beams having the wavelengths received by the photoelectric conversion element with a control signal;
a photodetector configured to receive each of the other laser beams reflected by the reflection switches; and
a management unit configured to reproduce information of the module by combining signals from the photodetectors.

5. A remote control method for an optical node, the remote control method comprising:
splitting laser beams having a plurality of wavelengths supplied through an optical fiber with a wavelength division multiplexing (WDM) coupler for each wavelength;
receiving and photoelectrically converting at least one of the laser beams split for each wavelength with a photoelectric conversion element;
storing electric power from the photoelectric conversion element in a power storage unit;
dividing information of a module into drive signals and driving each of the reflection switches by using electric power of the power storage unit; and
switching by using the drive signal the reflection switches between a reflection state and a non-reflection state with respect to the other laser beams split for each wavelength and returning the reflected laser beams to the optical fiber via the WDM coupler.

6. The remote control method according to claim 5, further comprising driving the module using electric power of the power storage unit according to a control signal included in the laser beams received by the photoelectric conversion element.

7. The remote control method according to claim 5, wherein the module is an optical sensor, a communication line changeover switch, or both.

8. The remote control method according to claim 5, for a monitoring control device connected to an optical node by an optical fiber, the remote control method comprising:
supplying, by a plurality of lasers, laser beams having wavelengths different from each other to the optical fiber;
modulating the laser beams having the wavelengths received by a photoelectric conversion element into a control signal;
receiving, by a photodetector, each of the other laser beams reflected by reflection switches; and
combining signals from the photodetector to reproduce information of the module.
